(19) United States
(12) Patent Application Publication
(10) Pub. No.: US 2016/0188254 A1
(43) Pub. Date: Jun. 30, 2016

(54) LIFECYCLE MANAGEMENT OF SOLID STATE MEMORY ADAPTORS

(71) Applicant: International Business Machines Corporation, Armonk, NY (US)

(72) Inventors: Craig A. Bickelman, Weatherly, PA (US); Edward W. Chencinski, Poughkeepsie, NY (US); Seth R. Greenspan, Pleasant Valley, NY (US); Adam J. McPadden, Underhill, VT (US); M. Dean Sciacca, Poughkeepsie, NY (US); Peter K. Szwed, Rhinebeck, NY (US)

(21) Appl. No.: 15/072,603

(22) Filed: Mar. 17, 2016

Related U.S. Application Data
(63) Continuation of application No. 14/208,248, filed on Mar. 13, 2014.

(51) Int. Cl. G06F 3/06

(52) U.S. Cl. CPC G06F 3/0649; G06F 3/0616; G06F 3/0653; G06F 3/0688

(57) ABSTRACT

Embodiments relate to lifecycle management of solid state memory adaptors. Aspects of the invention include monitoring a remaining life of each of a plurality of solid state memory adaptors in a system and creating a log of a wearing of each of the plurality of solid state memory adaptors. Aspects further include transmitting the log to a service element and receiving a supplemental data from the service element and determining a threshold value for each of the plurality of solid state memory adaptors. Based on determining that the remaining life of one of the plurality of solid state memory adaptors is below the threshold value for the one of the plurality of solid state memory adaptors, aspects also include creating a service call to request that the one of the solid state memory adaptors be replaced.

### DOMESTIC PRIORITY

This application is a continuation of the legally related U.S. application Ser. No. 14/208,248 filed Mar. 13, 2014, which is fully incorporated herein by reference.

### BACKGROUND

The present invention relates generally to solid state memory adaptors, and more specifically, to lifecycle management of solid state memory adaptors.

Solid state memory devices experience a substantial wear-out of cells over their lifetimes, requiring that solid state memory adaptors be over-provisioned with additional space that is dynamically configured into the storage arrays as memory cells within the storage array wear over time. Despite such over-provisioning, some solid state memory adaptors tend to wear out relatively rapidly in comparison to other storage devices such as DRAMs or hard spinning disk drives. Furthermore, there is a distribution of wear characteristics across the population of adaptors, so the wear of any specific adaptors is not generally predictable a priori.

Memory cells within a solid state memory adaptors wear at varying rates over time, resulting in the over-provisioned capacity gradually being reduced until it is completely gone. When the over-provisioned capacity is completely used, the solid state adaptor has essentially worn out, since there is no space to put further write data and the service provided by the adaptor can no longer continue.

Current systems utilize the solid state memory adaptors until they wear out, at which time the system either takes a loss of service or continues operation in an exposed state. An exposed state is one wherein the level of redundancy in the system is diminished by the loss of the memory cells on the adaptor that reached end of life or failed in some other way. Storage systems that are in exposed states result in far higher levels of risk of system service outages, since a failure while in this state has no redundancy to fall back on and recover from.

### SUMMARY

Embodiments include methods for lifecycle management of solid state memory adaptors by monitoring a remaining life of each of a plurality of solid state memory adaptors in a system and creating a log of a wearing of each of the plurality of solid state memory adaptors. The method also includes transmitting the log to a service element and receiving a supplemental data from the service element and determining a threshold value for each of the plurality of solid state memory adaptors. Based on determining that the remaining life of one of the plurality of solid state memory adaptors is below the threshold value for the one of the plurality of solid state memory adaptors, the method also includes creating a service call to request that the one of the solid state memory adaptor be replaced.

Embodiments also include a computer program product for lifecycle management of solid state memory devices, the computer program product including a tangible storage medium readable by a processing circuit and storing instructions for execution by the processing circuit for performing a method. The method includes monitoring a remaining life of each of a plurality of solid state memory adaptors in a system and creating a log of a wearing of each of the plurality of solid state memory adaptors. The method also includes transmitting the log to a service element and receiving a supplemental data from the service element and determining a threshold value for each of the plurality of solid state memory adaptors. Based on determining that the remaining life of one of the plurality of solid state memory adaptors is below the threshold value for the one of the plurality of solid state memory adaptors, the method also includes creating a service call to request that the one of the solid state memory adaptor be replaced.

Embodiments further include a computer system having a plurality of solid state memory adaptors, wherein each of the solid state memory adaptors includes a controller configured to monitor a wear level of each a plurality of solid state memory devices on the solid state memory adaptor and a host configured to store data on the plurality of solid state memory adaptors. The host includes a processor configured for performing a method that includes monitoring a remaining life of each of a plurality of solid state memory adaptors in a system and creating a log of a wearing of each of the plurality of solid state memory adaptors. The method also includes transmitting the log to a service element and receiving a supplemental data from the service element and determining a threshold value for each of the plurality of solid state memory adaptors. Based on determining that the remaining life of one of the plurality of solid state memory adaptors is below the threshold value for the one of the plurality of solid state memory adaptors, the method also includes creating a service call to request that the one of the solid state memory adaptor be replaced.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a block diagram of a computing system in accordance with an exemplary embodiment;

FIG. 2 depicts a block diagram of computing system having a solid state memory device in accordance with an exemplary embodiment; and

FIG. 3 is a block diagram illustrating a method for lifecycle management of solid state memory adaptors in accordance with an exemplary embodiment.

### DETAILED DESCRIPTION

In exemplary embodiments, methods and systems for lifecycle management of solid state memory adaptors are provided. In exemplary embodiments, a host monitors the operation of a plurality of solid state memory adaptors, also referred to as flash adapters, in a system. Based on a determination that one of the pluralities of solid state memory adaptors has a remaining life that is below a threshold value of being worn out, the host creates a service call, which is a notification that the solid state memory adaptor should be replaced.

By creating a service call before the solid state memory adaptor is worn out, the replacement may by scheduled at a time that insures traffic is limited to minimize the risk of recovery failure and potential consequences to the system. For those systems that are particularly sensitive to potential outages the solid state memory adaptor can be evacuated before service is performed. The system is then exposed in a controlled, reliable, well tested process. The solid state memory adaptor is then replaced and the storage arrays of the solid state memory adaptor are rebuilt using the new solid state memory adaptor to restore full RAID capability and robustness.

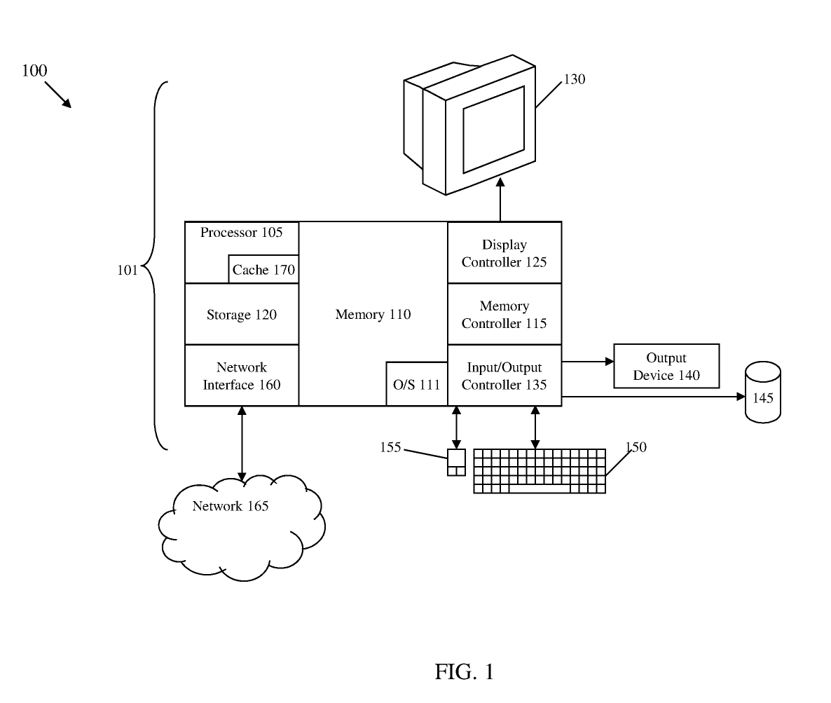

FIG. 1 illustrates a block diagram of an exemplary computer system 100 for use with the teachings herein. The methods described herein can be implemented in hardware software (e.g., firmware), or a combination thereof. In an exemplary embodiment, the methods described herein are implemented in hardware, and is part of the microprocessor of a special or general-purpose digital computer, such as a personal computer, workstation, minicomputer, or mainframe computer. The system 100 therefore includes general-purpose computer 101.

In an exemplary embodiment, in terms of hardware architecture, as shown in FIG. 1, the computer 101 includes a processor 105, memory 110 coupled via a memory controller 115, a storage device 120, and one or more input and/or output (I/O) devices 140, 145 (or peripherals) that are communicatively coupled via a local input/output controller 135. The input/output controller 135 can be, for example, but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components. The storage device 120 may include one or more hard disk drives (HDD), solid state drives (SSD), or any other suitable form of storage.

The processor 105 is a computing device for executing hardware instructions or software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions. The processor 105 may include a cache 170, which may be organized as a hierarchy of more cache levels (L1, L2, etc.).

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially controls the execution of other computer programs and provides scheduling, input-output control, file and data management, memory management, and communication control and related services.

In an exemplary embodiment, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In an exemplary embodiment, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In an exemplary embodiment, network 165 can be a managed IP network administered by a service provider. The network 165 may be implemented in a wireless fashion, e.g., using wireless protocols and technologies, such as Wi-Fi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the instructions in the memory 110 may further include a basic input output system (BIOS) (omitted for simplicity). The BIOS is a set of essential routines that initialize and test hardware at startup, start the OS 111, and support the transfer of data among the storage devices. The BIOS is stored in ROM so that the BIOS can be executed when the computer 101 is activated.

When the computer 101 is in operation, the processor 105 is configured to execute instructions stored within the memory 110, to communicate data to and from the memory 110, and to generally control operations of the computer 101 pursuant to the instructions.

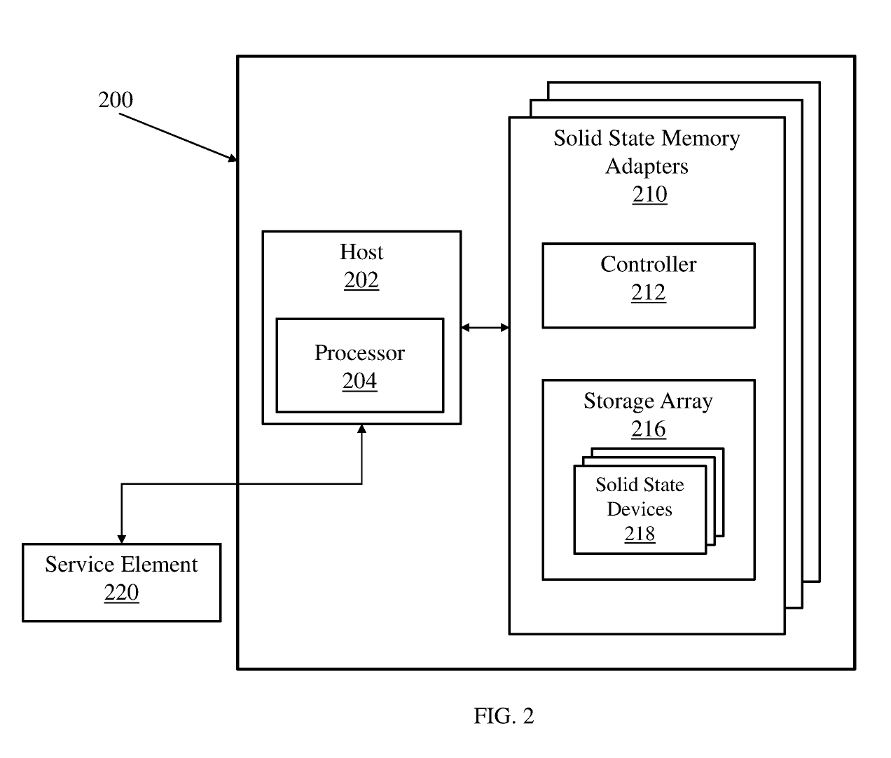

Referring now to FIG. 2, a block diagram of a computing system 200 including a solid state memory adaptor 210 in accordance with an exemplary embodiment is shown. As illustrated, the system 200 includes a host 202 having a processor 204 that is in communication with a plurality of solid state memory adaptors 210. In exemplary embodiments, each of the solid state memory adaptors 210 includes a controller 212, which controls the operation of the storage array 216 of the solid state memory adaptor 210. The storage array 216 includes a plurality of solid state memory devices 218, such as flash memory drives. In exemplary embodiments, the controller 212 may be a processor that is configured to utilize a RAID system across the plurality of solid state memory devices 218 for purposes of data redundancy and performance improvement. In exemplary embodiments, the host 202 is configured to select data to be written to the solid state memory adaptors 210 and to read data from the solid state memory adaptors 210.

In exemplary embodiments, the controller 212 is configured to store volatile state information of the solid state memory adaptor 210 and may include dynamic random access memory (DRAM) for storing the volatile state information. The volatile state information may include, but is not limited to, cache write information of the solid state memory adaptor 210, latch state information of the solid state memory adaptor 210, a wear level of each solid state memory device 218, a remaining life of the solid state memory adaptor 210, or the like. In exemplary embodiments, the storage array 216 includes non-volatile state information of the solid state memory adaptor 210, which may include, but is not limited to, program-erase (P/E) cycle counts, bit error rate data, logical to physical mappings, bad block data, and other metadata. In exemplary embodiments, data regarding each of the solid state memory devices 218 is collected during the manufacturing of the solid state adaptor 210 to insure that the wear level on all solid state memory devices 218 will make the solid state adaptor 210 perform as expected.

In exemplary embodiments, the host 202 communicates with the controller 212 of each of the solid state memory adaptors 210 and monitors a remaining life of each solid state memory adaptor 210. For example, the host 202 may issue periodic queries to the controller 212 for the remaining life of the solid state memory adaptor 210. In exemplary embodiments, either the controller 212 or the host 202, or both, may store collected information data regarding the wearing out of the solid state memory devices 218 of the solid state memory adaptors 210. This informational data can be used to analyze the wearing process of the solid state memory adaptors 210 and to calculate the remaining life of the solid state memory adaptors 210. In exemplary embodiments, the host 202 provides the informational data regarding the solid state memory adaptors 210 to a service element 220. In addition, the service element 220 may include information collected from solid state memory adaptors 210 that were analyzed after failing or being taken out of service.

In exemplary embodiments, the remaining life of a solid state memory adaptor 210 may be based on a wear level or the remaining life of the solid state memory devices 218 of the solid state memory adaptor 210. In one example, the remaining life of a solid state memory adaptor 210 may be the lowest remaining life of the solid state memory devices 218 of the solid state memory adaptor 210. In another example, the remaining life of a solid state memory adaptor 210 may be based on the number of solid state memory devices 218 of the solid state memory adaptor 210 that have not been worn out, i.e., the remaining storage capacity of the solid state memory adaptor 210.

In exemplary embodiments, upon determining that the remaining life of a solid state memory adaptor 210 falls below a threshold value, the host 202 issues a service call, which is a notification requesting the replacement of the solid state memory adaptor 210, to service element 220. In exemplary embodiments, the threshold value is based on the operational requirements of the host. The threshold value is selected to balance the efficient use of the available storage within the solid state memory adaptor 210 against the risk of a system outage if a solid state memory adaptor 210 is not replaced before it fails. In exemplary embodiments, the threshold value is a dynamic value that is based on a level of acceptable risk of downtime if a solid state memory adaptor 210 fails before being replaced, a level of acceptable risk of data loss if a solid state memory adaptor 210 fails before being replaced, and the added cost associated with replacing a solid state memory adaptor 210 before its actual end of life. For example, a host 202 that is used to process and store extremely critical data on a solid state memory adaptor 210 will have a higher threshold value than a host 202 which is used to process and store non-critical data.

In exemplary embodiments, the threshold value for replacement of a solid state memory adaptor 210 may also be based on historical data relating to the performance of other solid state memory adaptors. In one embodiment, the threshold value for replacing a solid state memory adaptor 210 may be adjusted based on the performance of solid state memory adaptors that share a common manufacturing history. For example, if a number of solid state memory adaptors that share a common manufacturing history are determined to wear out at a rate of twice the expected rate, the threshold value for a solid state memory adaptor 210 with the common manufacturing history can be increased. In extreme cases where the wear or failure rate for solid state memory adaptors with a common manufacturing history is very high, the threshold value can be drastically increased, thereby resulting in the early replacement of the solid state memory adaptors. In exemplary embodiments, the host 202 may receive information regarding the performance of solid state memory adaptors 210 that share a common manufacturing history from the service element 220.

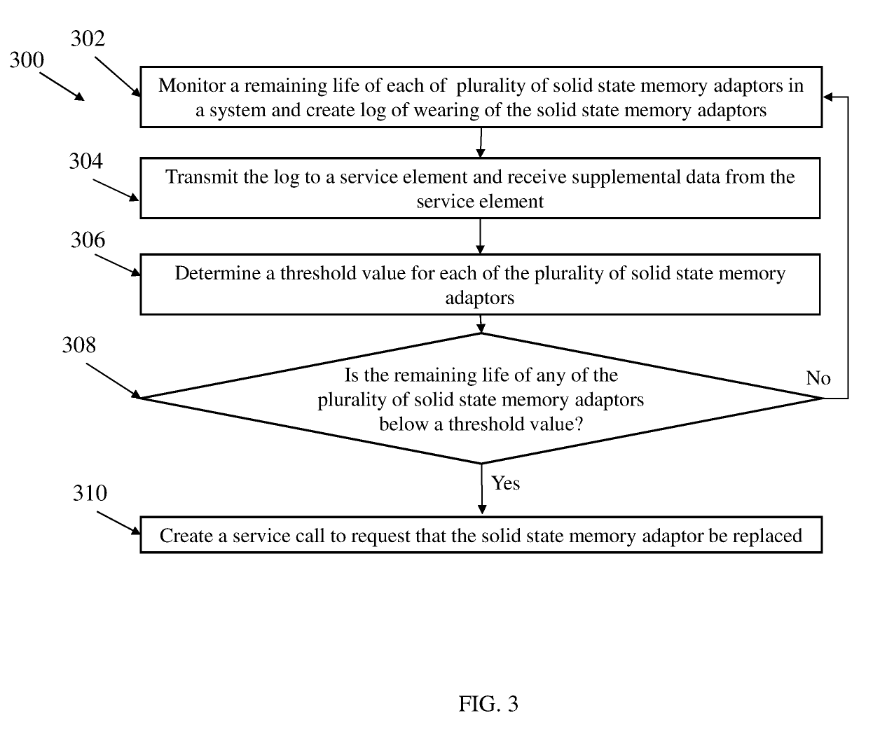

Referring now to FIG. 3 a block diagram illustrating a method 300 for lifecycle management of solid state memory adaptors in accordance with an exemplary embodiment is shown. As shown at block 302, the method 300 includes monitoring a remaining life of each of the plurality of solid state memory adaptors in a system and creating a log of the wearing of the solid state memory adaptors. Next, as shown at block 304, the method 300 includes transmitting the log to a service element and receiving supplemental data from the service element. In exemplary embodiments, the log includes information about the wearing of the solid state memory devices of the solid state memory adaptor and information concerning the operating conditions for the solid state memory adaptor. In exemplary embodiments, the supplemental data received from the service element includes wear aberrations of solid state memory adaptors having a manufacturing history with one of the plurality of solid state memory adaptors in the system. Next, as shown at block 306, the method 300 includes determining a threshold value for each of the plurality of solid state memory adaptors in the system. In exemplary embodiments, the threshold value for each of the solid state memory adaptors may be different and the threshold values may be based on the wearing of the solid state memory adaptors, the supplemental data and the operational requirements of the host. The threshold value is selected to balance the efficient use of the available storage within the solid state memory adaptor against the risk of a system outage if the solid state memory adaptor is not replaced before it fails.

Continuing with reference to FIG. 3, as shown at decision block 308, the method 300 includes determining if the remaining life of any of the plurality of solid state memory adaptors is below the threshold value for the solid state memory adaptor. If the remaining life of any of the plurality of solid state memory adaptors is below the threshold value for the solid state memory adaptor, the method 300 proceeds to block 310 and creates a service call to request that the solid state memory adaptor be replaced. Otherwise, the method 300 returns to block 302 and continues to monitor the remaining life of each of plurality of solid state memory adaptors in the system.

In exemplary embodiments, during the service call to replace the solid state memory adaptor, measures can be taken to minimize the risk of system service outage. In many cases, systems can have various RAID redundancy techniques which safeguard the host system against the failure of a solid state memory adaptor. However, such redundancy-based recovery techniques are not always effective. Among the factors that can lower their effectiveness is the level of system traffic at the time of the service disruption, because all recovery requires time to perform which is increased to a possibly untenable level when heavy system traffic is experienced. Accordingly, service calls may be scheduled at a relatively quiet time to optimize recovery effectiveness. Furthermore, traffic control features within the host system can be utilized to drastically limit or even prevent traffic from accessing the solid state memory adapter while it is under service. In exemplary embodiments, adaptors that are failing at a faster, more aggressive rate than would allow survival during the normal period of delay to service can be scheduled for an expedited service call.

In exemplary embodiments, the service element can perform global aging trend analysis across the full population of solid state memory devices in all host systems. This aging analysis not only provides data that is used to determine the threshold values, but also allows for other corrective action of technology or design problems, as well as adjustments of the options given or recommended to the operators of each system. In exemplary embodiments, the global aging trend data can be used to custom balance the cost of replacement for solid state memory adaptors and the level of service risk on a host system by host system basis. Furthermore, process improvements that yield better devices can be identified by studying the aging of the population of solid state memory adapters in the field and executing analytics to identify manufacturing issues.

In exemplary embodiments, by detecting and replacing solid state memory adaptors before the solid state memory adaptors wear out, the risk of system outages due to solid state memory adaptors failure can be reduced. In addition to the in-system monitoring that occurs for host systems in the field, the same techniques can be applied to systems being tested before shipping out as new builds to customers. The disclosed design enables the vender to insure that drives which are shipped as new meet the criteria for remaining life.

In exemplary embodiments, once a solid state memory adaptor is determined to have a remaining life below a threshold value, but before the adapter is replaced, the host make reconfigure write intensive solid state memory adaptor to be used as read intensive solid state memory adaptor such as to minimize the risk of serious consequences from rapid wear-out of the solid state memory adaptor.

As will be appreciated by one skilled in the art, one or more aspects of the present invention may be embodied as a system, method or computer program product. Accordingly, one or more aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, one or more aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code, when created and stored on a tangible medium (including but not limited to electronic memory modules (RAM), flash memory, Compact Discs (CDs), DVDs, Magnetic Tape and the like is often referred to as a “computer program product”. The computer program product medium is typically readable by a processing circuit preferably in a computer system for execution by the processing circuit. Such program code may be created using a compiler or assembler for example, to assemble instructions, that, when executed perform aspects of the invention.

The terminology used herein is for the purpose of describing particular embodiments only and is not intended to be limiting of embodiments. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments have been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiments were chosen and described in order to best explain the principles and the practical application, and to enable others of ordinary skill in the art to understand the embodiments with various modifications as are suited to the particular use contemplated.

Computer program code for carrying out operations for aspects of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments are described above with reference to flowchart illustrations and/or schematic diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for lifecycle management of solid state memory adaptors, the method comprising:
monitoring, by a processor, a remaining life of each of a plurality of solid state memory adaptors in a system;
creating a log of a wearing of each of the plurality of solid state memory adaptors;
transmitting the log to a service element and receiving a supplemental data from the service element, wherein the supplemental data comprises data regarding a failure rate of solid state memory adaptors having a common manufacturing history to one of the plurality of the solid state memory adaptors;
determining a threshold value for each of the plurality of solid state memory adaptors, wherein the threshold value for each of the plurality of solid state memory adaptors is based on the supplemental data and the log of wearing of each of the solid state memory adaptors and further based on a level of acceptable risk of downtime of the system if one of the plurality of solid state memory adaptors fails before being replaced, wherein the threshold value for each of the plurality of solid state memory adaptors is independently determined;
based on determining that the remaining life of one of the plurality of solid state memory adaptors is below the threshold value for the one of the plurality of solid state memory adaptors, creating a service call to request that the one of the solid state memory adaptor be replaced;
testing each of the plurality of solid state memory adaptors following manufacturing of each of each of the plurality of solid state memory adaptors, and
based on determining that the remaining life of one of the plurality of solid state memory adaptors is below a new build threshold value for the one of the plurality of solid state memory adaptors, replacing that solid state memory adaptor before shipping.
